(19) United States
(12) Patent Application Publication
(10) Pub. No.: US 2015/0206164 A1
(43) Pub. Date: Jul. 23, 2015

(54) PAYMENT PROCESS

(71) Applicant: Payment Power Technologies, Inc., Plantation, FL (US)

(72) Inventors: Alberto Jose Espana, Plantation, FL (US); Reinaldo Andres Espana Presas, Caracas (VE); Juan Francisco Espana Presas, Escazu (CR)

(21) Appl. No.: 14/603,291

(22) Filed: Jan. 22, 2015

Related U.S. Application Data
(60) Provisional application No. 61/930,215, filed on Jan. 22, 2014.

(51) Int. Cl. G06Q 30/02

(52) U.S. Cl. CPC G06Q 30/0222; G06Q 30/0261; G06Q 30/0267; G06Q 30/0253

(57) ABSTRACT

A computer-implemented method and computing system includes receiving, at a server computing device, customer location information and at least one of a product scan or a product purchase amount. The method may further include storing at least one customer selected payment method at the server computing device and communicating at least one of the customer location information and the at least one product scan or product purchase amount to at least one third party server computing device. The method may also include receiving, at the server computing device, one or more payment offers from the at least one third party server computing device and transmitting the one or more payment offers to a mobile computing device associated with the customer.

### CROSS-REFERENCE TO RELATED APPLICATIONS

This application claims the benefit of U.S. Provisional Application having Ser. No. 61/930,215, filed Jan. 22, 2014, of which the entire contents are incorporated herein by reference.

### TECHNICAL FIELD

This disclosure relates to sales processes and, more particularly, to a method for providing a consumer with various payment options, in real-time, at the point of sale and prior to making a purchase.

### BACKGROUND

Today, credit issuers offer customers multiple discounts, rewards or special financing terms for credit or debit purchases directly to their customers. Examples can be viewed in the issuer web pages or sent to customers via email or direct mail. However, these offers tend to be static in the sense that is up to the customer to activate the offer by visiting the specific retailer and using the credit or debit product associated with the offer.

### SUMMARY OF DISCLOSURE

In a first implementation, a computer-implemented method includes receiving, at a server computing device, customer location information and at least one of a product scan or a product purchase amount. The method may further include storing at least one customer selected payment method at the server computing device and communicating at least one of the customer location information and the at least one product scan or product purchase amount to at least one third party server computing device. The method may also include receiving, at the server computing device, one or more payment offers from the at least one third party server computing device and transmitting the one or more payment offers to a mobile computing device associated with the customer.

One or more of the following features may be included. In some embodiments, transmitting may include transmitting a user selectable option configured to allow the customer to select from the one or more payment offers. The method may further include transmitting a code configured for display on the mobile computing device, wherein the code corresponds to a customer selected payment offer. The at least one third party server computing device may be affiliated with one or more of a bank, a credit card company, a retailer, an online payment service and a mobile payment service. The one or more payment offers may include at least one of a credit card offer, a gift card offer, and a product discount. The one or more payment offers may be tailored for the customer and are received in response to a possible purchase event notification received from the mobile computing device. The server computing device may be configured to directly settle a transaction between a retailer and a bank based upon, at least in part, the customer selected payment offer.

In another implementation, a computing system includes a processor and memory configured to perform operations including receiving, at a server computing device, customer location information and at least one of a product scan or a product purchase amount. Operations may further include storing at least one customer selected payment method at the server computing device and communicating at least one of the customer location information and the at least one product scan or product purchase amount to at least one third party server computing device. Operations may also include receiving, at the server computing device, one or more payment offers from the at least one third party server computing device and transmitting the one or more payment offers to a mobile computing device associated with the customer.

One or more of the following features may be included. In some embodiments, transmitting may include transmitting a user selectable option configured to allow the customer to select from the one or more payment offers. Operations may further include transmitting a code configured for display on the mobile computing device, wherein the code corresponds to a customer selected payment offer. The at least one third party server computing device may be affiliated with one or more of a bank, a credit card company, a retailer, an online payment service and a mobile payment service. The one or more payment offers may include at least one of a credit card offer, a gift card offer, and a product discount. The one or more payment offers may be tailored for the customer and are received in response to a possible purchase event notification received from the mobile computing device. The server computing device may be configured to directly settle a transaction between a retailer and a bank based upon, at least in part, the customer selected payment offer.

In another implementation, a non-transitory computer-readable storage medium having stored thereon instructions that when executed by a machine result in one or more operations is provided. Operations may include receiving, at a server computing device, customer location information and at least one of a product scan or a product purchase amount. Operations may further include storing at least one customer selected payment method at the server computing device and communicating at least one of the customer location information and the at least one product scan or product purchase amount to at least one third party server computing device. Operations may also include receiving, at the server computing device, one or more payment offers from the at least one third party server computing device and transmitting the one or more payment offers to a mobile computing device associated with the customer.

One or more of the following features may be included. In some embodiments, transmitting may include transmitting a user selectable option configured to allow the customer to select from the one or more payment offers. Operations may further include transmitting a code configured for display on the mobile computing device, wherein the code corresponds to a customer selected payment offer. The at least one third party server computing device may be affiliated with one or more of a bank, a credit card company, a retailer, an online payment service and a mobile payment service. The one or more payment offers may include at least one of a credit card offer, a gift card offer, and a product discount. The one or more payment offers may be tailored for the customer and are received in response to a possible purchase event notification received from the mobile computing device. The server computing device may be configured to directly settle a transaction between a retailer and a bank based upon, at least in part, the customer selected payment offer.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes payment process according to an embodiment of the present disclosure;

FIG. 2 is a flowchart of payment process of FIG. 1 according to an embodiment of the present disclosure;

FIG. 3 is a diagrammatic view of a payment process according to an embodiment of the present disclosure;

FIG. 4 is a diagrammatic view of a payment process according to an embodiment of the present disclosure;

FIG. 5 is a diagrammatic view of a payment process according to an embodiment of the present disclosure;

FIG. 6 is a diagrammatic view of a payment process according to an embodiment of the present disclosure;

FIG. 7 is a diagrammatic view of a payment process according to an embodiment of the present disclosure;

FIG. 8 is a diagrammatic view of a payment process according to an embodiment of the present disclosure;

FIG. 9 is a diagrammatic view of a payment process according to an embodiment of the present disclosure;

FIG. 10 is a diagrammatic view of a payment process according to an embodiment of the present disclosure;

FIG. 11 is a diagrammatic view of a computing device according to an embodiment of the present disclosure;

FIG. 12 is a diagrammatic view of a payment process according to an embodiment of the present disclosure;

FIG. 13 is a diagrammatic view of a payment process according to an embodiment of the present disclosure;

FIG. 14 is a diagrammatic view of a payment process according to an embodiment of the present disclosure;

FIG. 15 is a diagrammatic view of a payment process according to an embodiment of the present disclosure;

FIG. 16 is a diagrammatic view of a payment process according to an embodiment of the present disclosure;

FIG. 17 is a diagrammatic view of a payment process according to an embodiment of the present disclosure; and

FIG. 18 is a diagrammatic view of a payment process according to an embodiment of the present disclosure.

Like reference symbols in the various drawings may indicate like elements.

### DETAILED DESCRIPTION OF THE EMBODIMENTS

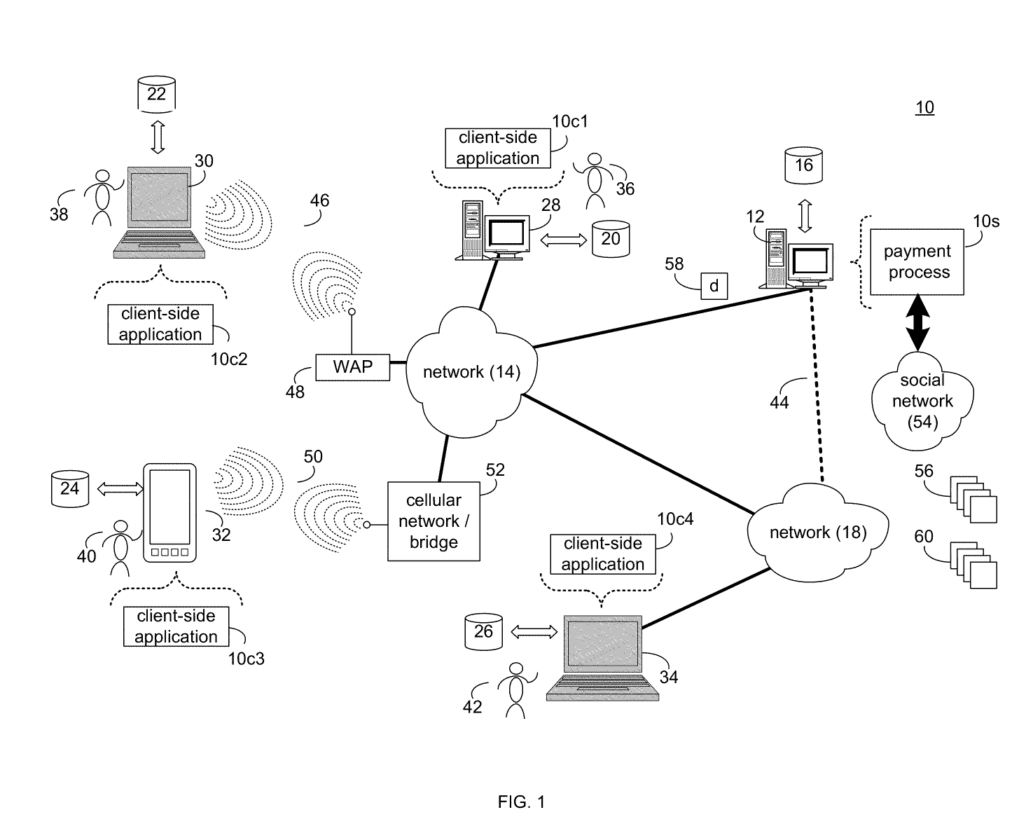

Referring to FIG. 1, there is shown payment process 10. For the following discussion, it is intended to be understood that payment process 10 may be implemented in a variety of ways. For example, payment process 10 may be implemented as a server-side process, a client-side process, or a server-side/client-side process. Any user, if they so choose, may elect to disable any or all of the features associated with payment process 10.

For example, payment process 10 may be implemented as a purely server-side process via payment process 10s. Alternatively, payment process 10 may be implemented as a purely client-side process via one or more of client-side application 10c1, client-side application 10c2, client-side application 10c3, and client-side application 10c4. Alternatively still, payment process 10 may be implemented as a server-side/client-side process via payment process 10s in combination with one or more of client-side application 10c1, client-side application 10c2, client-side application 10c3, and client-side application 10c4.

Accordingly, payment process 10 as used in this disclosure may include any combination of payment process 10s, client-side application 10c1, client-side application 10c2, client-side application 10c3, and client-side application 10c4.

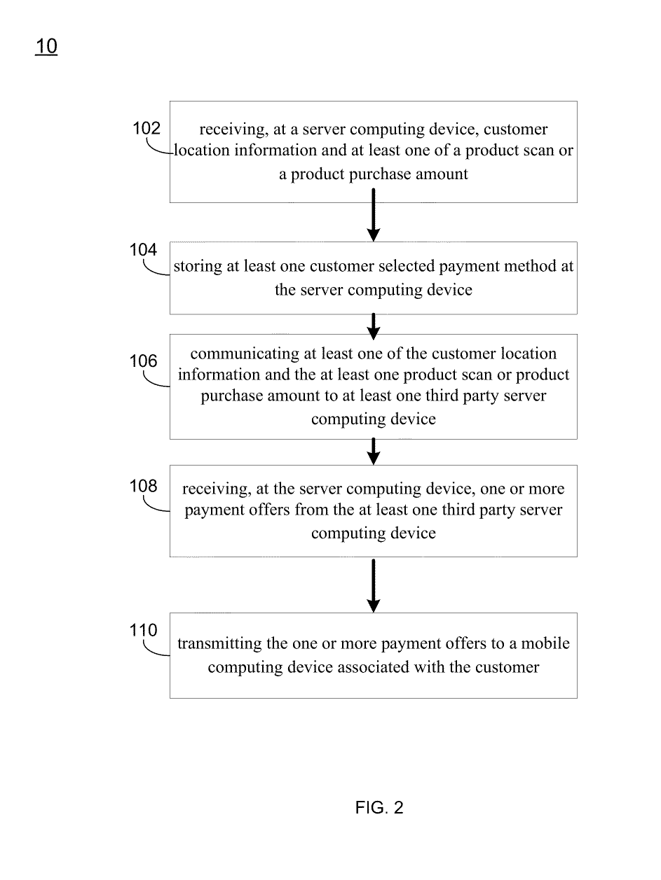

Referring also to FIG. 2 and as will be discussed below in greater detail, payment process 10 may include receiving (102), at a server computing device, customer location information and at least one of a product scan or a product purchase amount. The method may further include storing (104) at least one customer selected payment method at the server computing device and communicating (106) at least one of the customer location information and the at least one product scan or product purchase amount to at least one third party server computing device. The method may also include receiving (108), at the server computing device, one or more payment offers from the at least one third party server computing device and transmitting (110) the one or more payment offers to a mobile computing device associated with the customer.

Payment process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of payment process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, a television user interface, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, desktop computer 28, laptop computer 30, data-enabled, cellular telephone 32, notebook computer 34, a server computer (not shown), a personal gaming device (not shown), a data-enabled television console (not shown), a personal music player (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access payment process 10 directly through network 14 or through secondary network 18. Further, payment process 10 may be accessed through secondary network 18 via link line 44.

The various client electronic devices (e.g., client electronic devices 28, 30, 32, 34) may be directly or indirectly coupled to network 14 (or network 18). For example, desktop computer 28 is shown directly coupled to network 14 via a hardwired network connection. Laptop computer 30 is shown wirelessly coupled to network 14 via wireless communication channel 46 established between laptop computer 30 (respectively) and wireless access point (i.e., WAP) 48, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Further, data-enabled, cellular telephone 32 is shown wirelessly coupled to network 14 via wireless communication channel 50 established between data-enabled, cellular telephone 32 and cellular network/bridge 52, which is shown directly coupled to network 14. Additionally, notebook computer 34 is shown directly coupled to network 18 via a hardwired network connection.

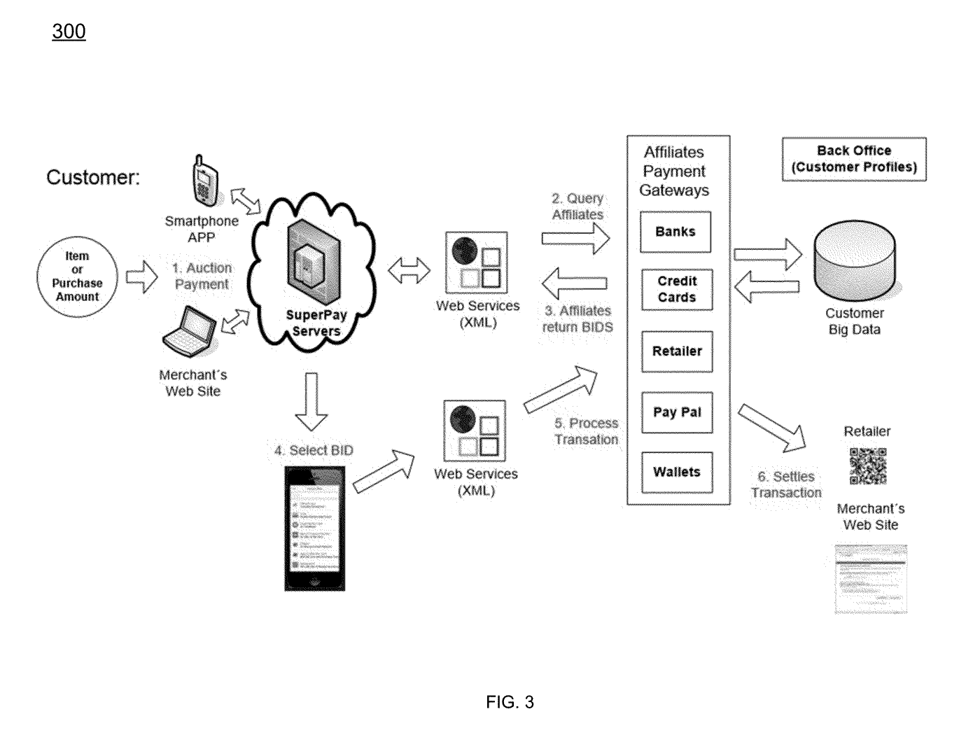

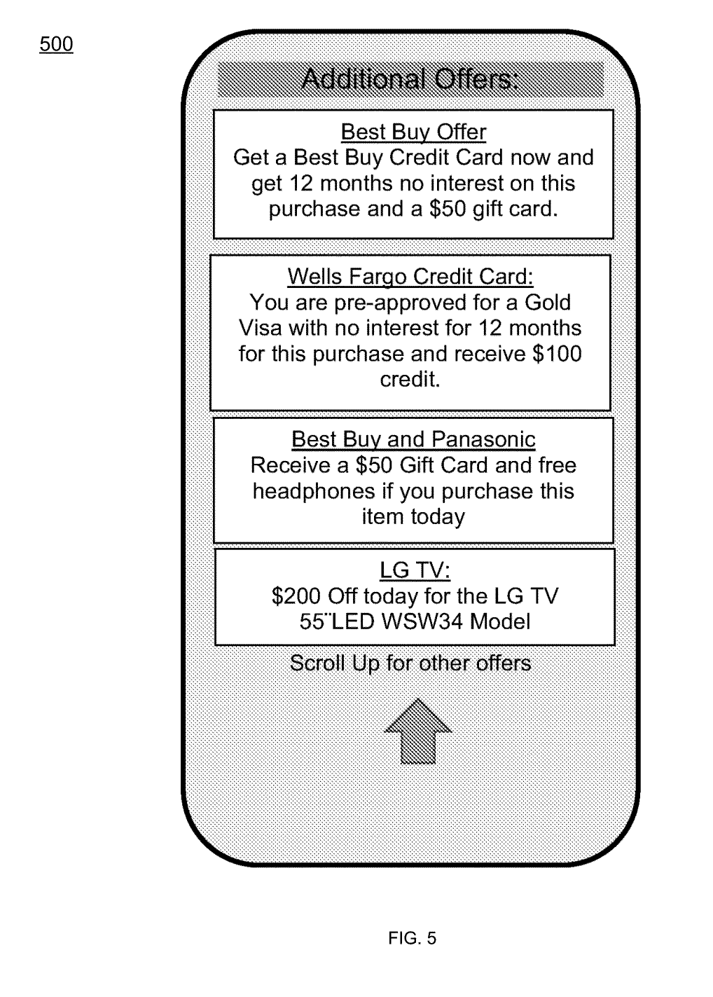

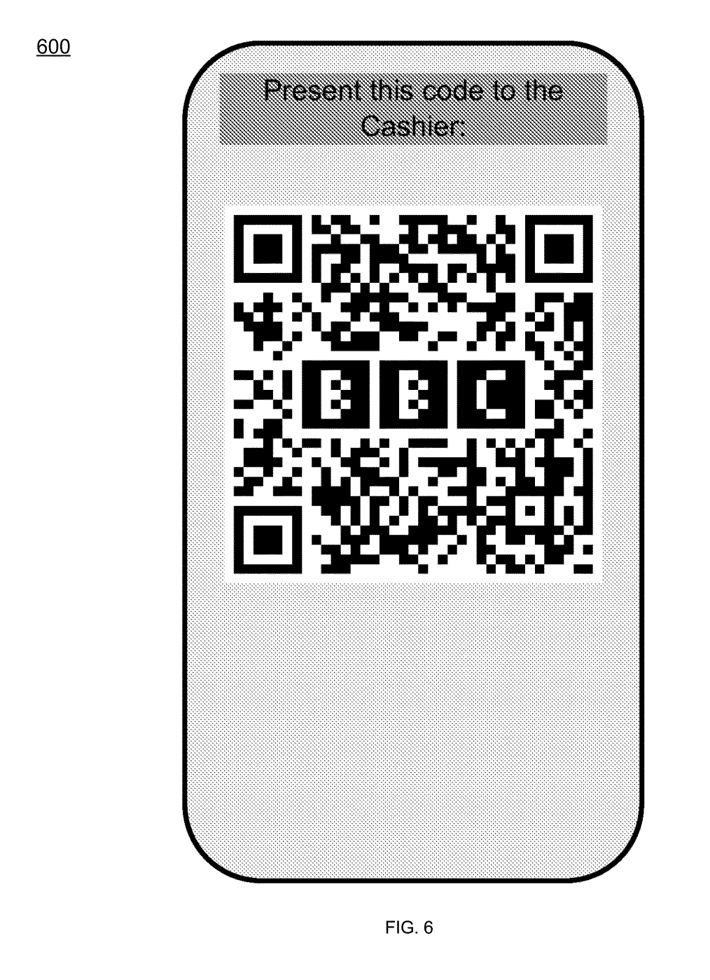

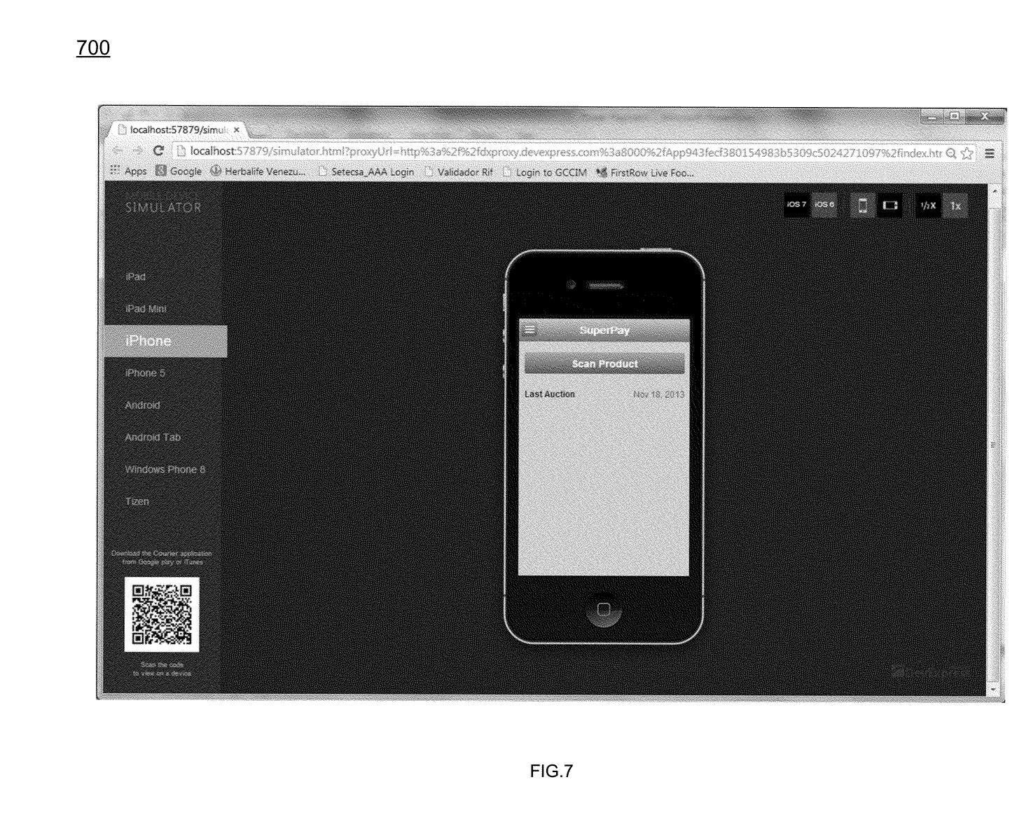

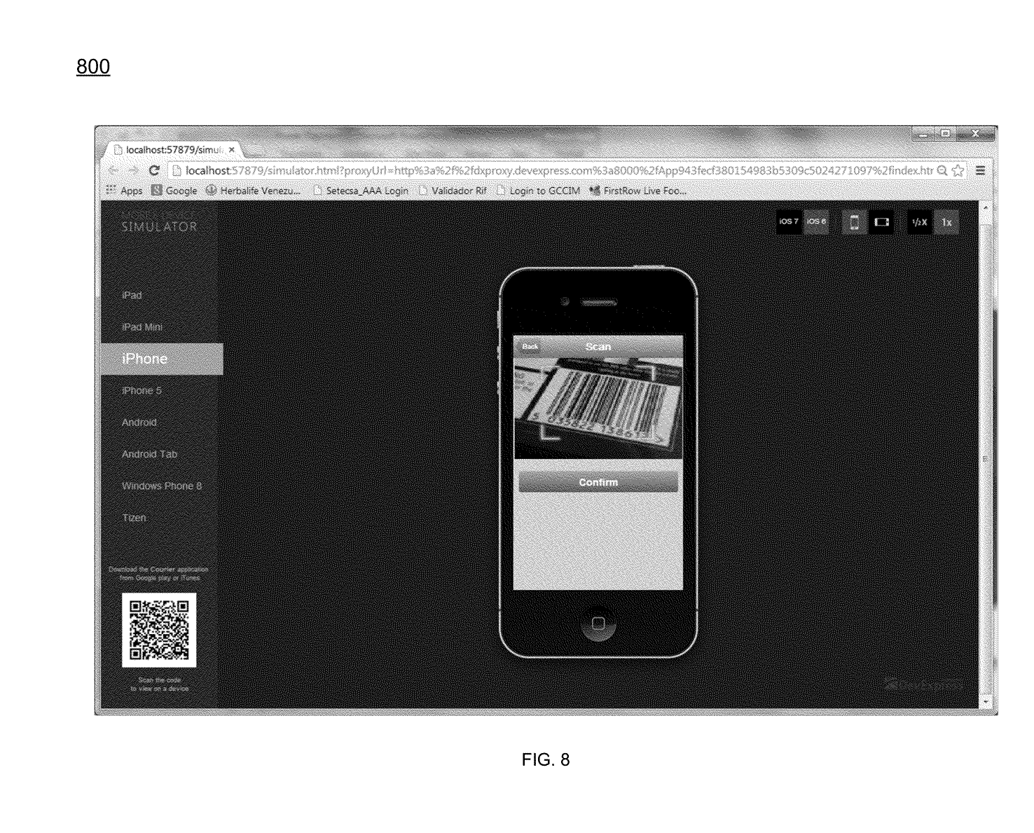

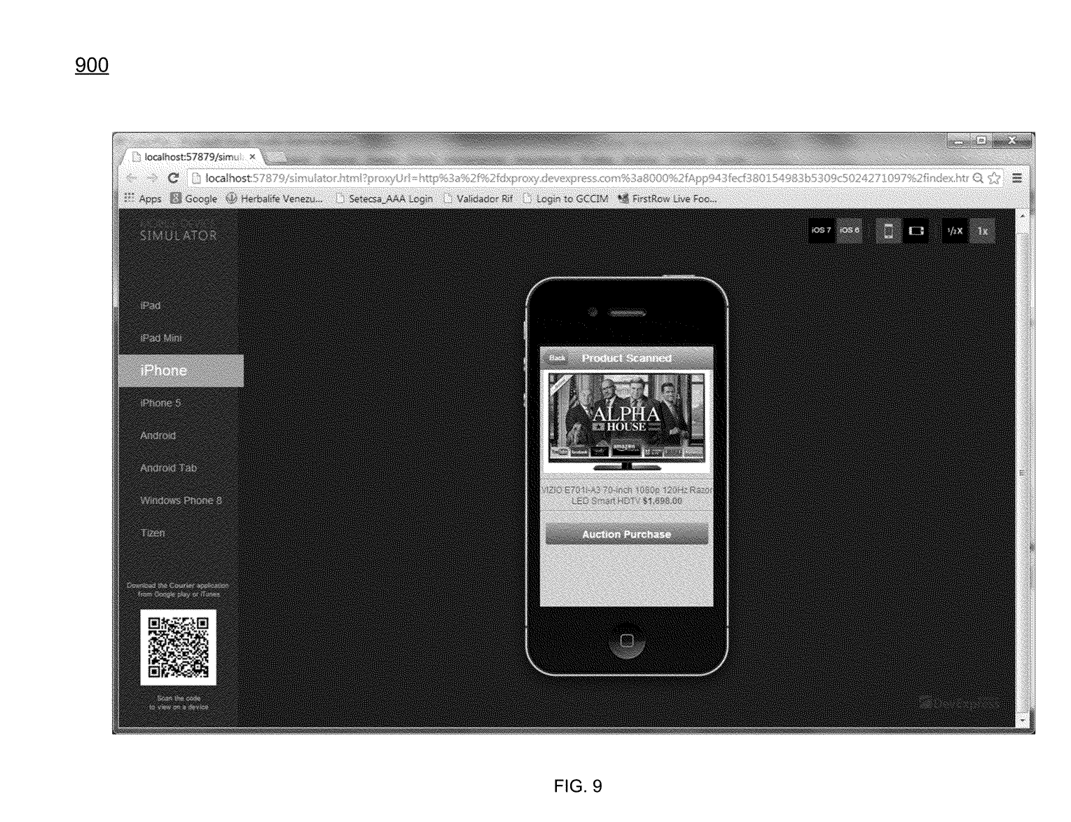

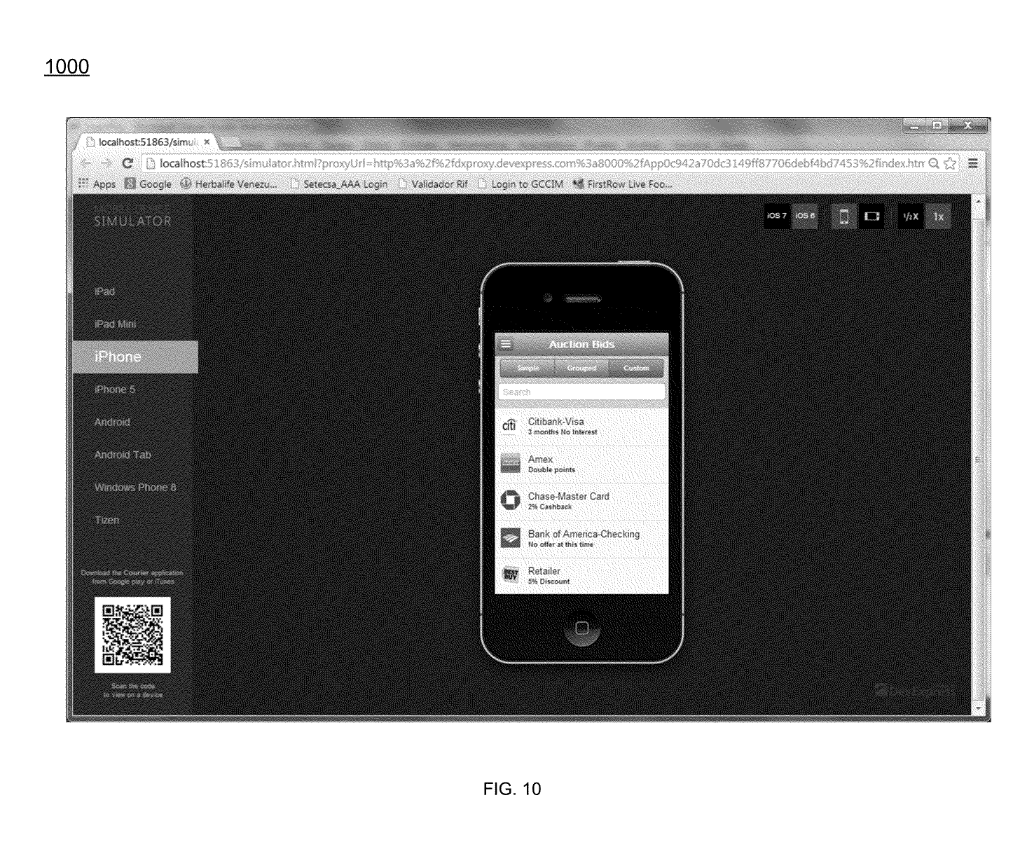

Referring now to FIGS. 3-18 embodiments of payment process 10 are provided. Embodiments of payment process 10 may be configured to offer retail customers the ability to auction a large ticket purchase to credit issuers, or financial institutions to obtain the best payment offer for a specific purchase near real time. As discussed above, credit issuers offer customers multiple discounts, rewards or special financing terms for credit or debit purchases directly to their customers. Examples can be viewed in the issuer web pages or sent to customers via email or direct mail. However, these offers tend to be static in the sense that is up to the customer to activate the offer by visiting the specific retailer and using the credit or debit product associated with the offer. Embodiments of payment process 10 may be configured to alter this model and empower the consumer to auction a soon to be made purchase so financial institutions may make a real time offer for the planned purchase.

For example, suppose for a moment that a customer (John Smith) has registered his credit and debit accounts with payment process 10 via the web or a smartphone application such as those shown in FIG. 1. Now, the customer may be visiting a retail store and plans to make a big ticket item purchase of a television set. There are a few different scenarios where payment process 10 may be involved:

In one example, the customer (John Smith) may select a Panasonic LED 55′ television with a value of $1098. In this case, the customer may have performed research via the web, or may have been convinced by the store salesperson that this is the television that he/she is interested in. Now, John is getting ready to pay and he activates the client application associated with payment process 10 in his smartphone. The application associated with payment process 10 may be configured to determine the customer's location using GPS, Wifi and/or any other suitable approach. Payment process 10 may be further configured to present the store information to the customer for confirmation and to request the product scan or purchase amount.

For example, client application associated with payment process 10 may be configured to display the following:

TABLE 1

| | |
|---|---|
| You are at: | SuperPay |

Best Buy -1344 Oakland Av. San Francisco, CA
Please scan product or enter purchase amount:
$

The customer may decide to scan the product QRC or Bar Code into the application.

TABLE 2

| | |
|---|---|
| Please confirm: | SuperPay |

Best Buy -1344 Oakland Av. San Francisco, CA
Purchasing a Panasonic LED 55″TV for: $

The customer enters the amount of $1098.00 and may select the auction payment option on his/her mobile device. At this point, payment process 10, via the client application, may perform a number of processes. For the purposes of this example, suppose that John had registered the following payment methods: Citibank Visa Credit Card, Chase Gold Mastercard, American Express Gold Card and Bank of America Debit Card. Payment process 10 may then connect to each financial institution via a pre-established, secure, web service connection to inform the financial institutions that John intends to buy a TV for $1098 in the next few minutes and he would like to receive the best offer for this specific payment. Accordingly, payment process 10 may allow banks or financial institutions to compete at the time of an intended purchase with offers or benefits tailored specifically for a particular customer.

In some embodiments, payment process 10 may be configured to connect via a webservice, or other suitable approach, to other players in the payment such as the retailer (e.g., Best Buy, etc.), a payment brand (e.g., Visa, Mastercard, Amex, etc.) or a manufacturer (e.g., Panasonic). Payment process 10 may also connect to other institutions/manufacturers that have signed up with the host company of payment process 10 to offer special offers to prospects. In this particular example, John may wait for a few seconds while payment process 10 contacts all players in the transaction to receive different offers. These offers may be personally tailored for each consumer based on a number of different factors. Some of which may include, but are not limited to, the location, the consumer, payment product, and/or a profile set up in the application. The profile may include any number of user preferences including information about the user, etc.

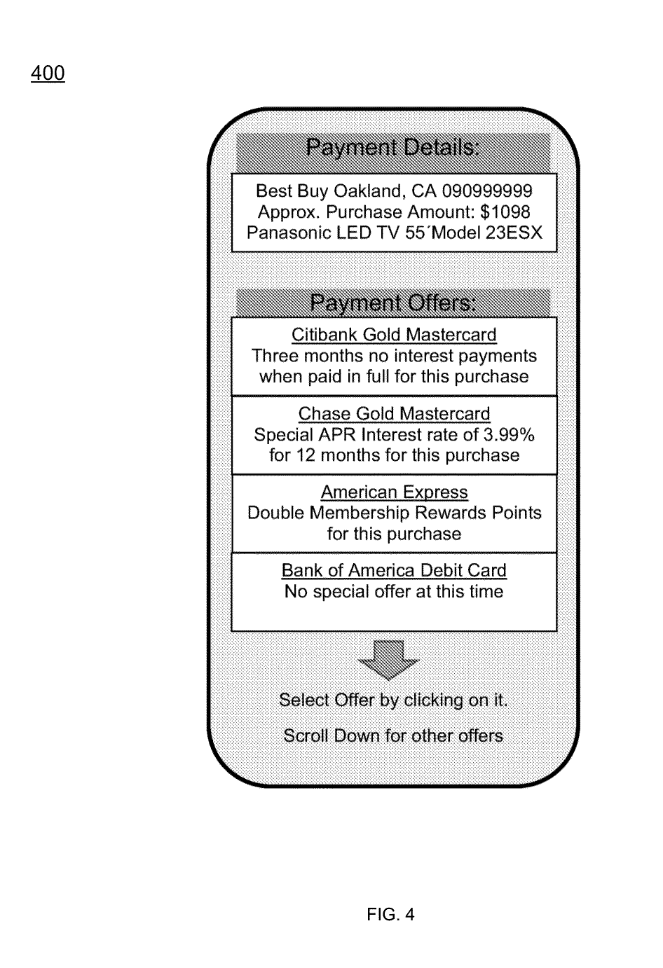

Referring now to FIGS. 4-6, a number of graphical user interfaces may be displayed to the user. As is shown in FIG. 4, the customer may be presented with the best offer for the specific purchase from his registered credit cards. In addition, other offers can be presented. Other financial institutions can compete for the customer and its purchase at this time and the retailer can strengthen the offer to ensure the sale is not lost.

Here, the user may proceed to select the best offer for him. In this particular case he wants to pay with his Citibank Credit Card and get a $50 Gift Card from Best Buy for this particular purchase. Accordingly, John may select the two offers and may select the auction payment option on his/her mobile device. Payment process 10 may then connect to Citibank and obtain an authorization code for this transaction (e.g., probably for $1300 to cover taxes, etc.). Payment process 10 may then connect to Best Buy to obtain a code for the $50 Gift Card. Payment process 10 may then return a bar code, QRC to present to the cashier at the time of purchase. The cashier may then scan the item for payment with the gift card being added automatically to the checkout screen and then the cashiers selects the complete sale button. The retailer's system may connect with payment process 10 servers securely and may transmit the payment process 10 authorization code. Payment process 10 may validate the authorization code and issue a final approval code to the retailer. Payment process 10 may also sends an email message to the user detailing the transaction just made for information and security purposes.

At this point, payment process 10 and its associated servers may be in possession of a great deal of information. Some of which may include, but is not limited to, the final amount paid by customer (e.g. $1213.22), the offer accepted and the financial institution, the customer's credit card information for the financial institution, the certainty that this is the true customer making the purchase, and the retailer where the purchase was made. Accordingly, payment process 10 may differ from a credit card company such as Visa or Mastercard. In this way, payment process 10 may now be able to settle the transaction between the retailer and the bank without having to send the transaction via these traditional networks.

At this point, in some embodiments, payment process 10 may be configured to send a transaction confirmation message with the purchase details of the final amount and the offer accepted to the financial institution. In this scenario, even the credit card does not have to be sent in the message. The parent or host of payment process 10 and the financial institution may have agreed on a client number to be used and the financial institution maintains secret the customer's credit card information. Additionally and/or alternatively payment process 10 may collect first from the financial institution minus the agreed interchange rate (say 0.5%) and may pay the retailer the second day minus the interchange rate (0.5%) and a fee associated with using payment process 10. As such, fraud disputes should be near zero since the customer has been authenticated prior to purchases. Other disputes should be settled between the retailer and the customer. Now, the customer has the power to auction large ticket item payments and obtain the best offers for goods and payments augmenting their purchasing power.

In some embodiments, customers can auction an approximate purchase amount when going into a store (e.g., selecting a $1000 purchase at HH Gregg when going into the store to browse). Additionally and/or alternatively, customers may ask for offers when going into a retail store or online to determine any special deals available from the retailer and the payment company.

Accordingly, payment process 10 may assist credit and debit issuers, payment brands, retailers, as well as the customer. Banks may be able to compete for transactions at the point of sale, other banks may have access to a pool of new customers, retailers may protect their physical store sales with an innovative approach, payment brands can support financial institutions by offering special rewards or incentives, manufacturers may also be able to showcase offers to customers at the time of purchase and finally the customer will benefit with better pricing and payment terms. Payment process 10 (and the associated host or parent company) can collect fees from each participant in the transaction and lower the overall cost of a purchase transaction to all parties involved.

In some embodiments, and as discussed herein, payment process 10 may provide a payment application to empower customers to receive the best possible offer for paying for purchases. Payment process 10 may provide substantial benefits to consumers, retailers, banks, issuers, etc. For consumers, payment process 10 may increase the purchasing power of consumer and provide added benefits from payment methods. For retailers, payment process 10 may offer innovative benefits tied to a purchase at the retailer, lower interchange costs, and increase loyalty from consumers. For banks and issuers, payment process 10 may provide a new approach to compete for purchases at time of transaction, increased loyalty, and a new acquisition channel.

In another example, a user may select an item or amount at a specific retailer (e.g. $1000 Vizio TV from Best Buy in Lantana, Calif.). Here, the user may have registered payment options with payment process 10 (e.g., credit/debit cards, bank accounts, paypal, cash, etc.). The user may apply payment process 10 prior to the purchase. In this way, payment process 10 may be configured to present and/or display offers from existing payment options, present offers from retailers, present offers from new payment options, present offers from manufacturer, etc.). The user may also select the payment option (e.g. CITI, 3 months no interest payment +$50 gift card from Vizio). The user may show the payment token at the cash register (e.g. cellphone with qr code as is shown in the FIGS., etc,). In some embodiments, payment process 10 may perform settlement of the transaction between the retailer and payment method.

In another example, a customer may visit a retail store and decide which product to purchase or choose an approximate amount to spend at the store. Here, assume again that the customer has pre-registered his existing payment accounts such as credit cards, debit cards, bank accounts with payment process 10. If the user activates the client application associated with payment process 10, payment process 10 may then detect the retail store location and product to be purchased, search available offers for the specific payment transaction making payment companies compete for the transaction, search for new offers from retailer, Banks or Manufacturers, present offers to the consumer. The consumer may then be presented with and select the best payment option for his need. Payment process 10 may then obtain authorization for the transaction from the selected payment method and issue payment token to be presented to the retailer. Payment process 10 may collect first from the payment company and then pays the retailer.

In some embodiments, payment process 10 may allow for revenue generation through a variety of different channels. Some of these may include, but are not limited to, banks, retailers, manufacturers, payment processing, cross sell products, consumer—app, online payment button, wallet for small purchases, alerts for payment management, etc.

In some embodiments, payment process 10 may include a number of revenue drivers. Some of these may include, but are not limited to, charge banks/credit issuers to offer this service to their customers, sell the service to retailers as a value added payment option to retain customers, and new acquisition channel for private credit products. Other revenue drivers may include offer service to credit issuers to acquire customers at the time of a transaction, offer service to product manufacturers to increase sales at specific retailers, process payment between payment companies and retailers (e.g., flipping the credit card model of today by collecting from credit company first and then paying the retailer at a much lower interchange rate), cross sell products at the time of purchase (offer this service to retailers), sell the App to consumers at a low price or free to encourage usage (offer alert services for payments to ensure customers pay on time to enjoy benefits of the offer), offer the service to online retailers, develop a proprietary prepaid wallet for small purchases, etc.

In some embodiments, payment process 10 may provide the option of offers that may appear on the app at the moment of sending the information to the server. For example, payment process 10 may utilize an internal process occurs on a server computing device (e.g. server computing device 12) prior to sending the resulting offers back to the user. Accordingly, payment process 10 may include receiving, at a server computing device, customer location information and at least one of a product scan or a product purchase amount or a user selected offer. The method may further include storing at least one customer selected payment method at the server computing device and communicating at least one of the customer location information and the at least one product scan or product purchase amount to at least one third party server computing device. The method may also include receiving, sorting, filtering and prioritizing, at the server computing device, one or more payment offers from the at least one third party server computing device and transmitting the one or more payment offers to a mobile computing device associated with the customer.

It should be noted that payment offers may be personalized for each consumer. In this way, payment process 10 may receive a number of offers from different institutions and may determine, and subsequently present, the appropriate offer to the consumer based upon a number of factors, some of which may include, but are not limited to, the location and profile set up in the application. Payment process 10 may also provide a payments marketplace where banks compete for the payment as described above. Embodiments of payment process 10 may also be delivered via a web page, for example, when a consumer is ready to check out and pay at a online store.

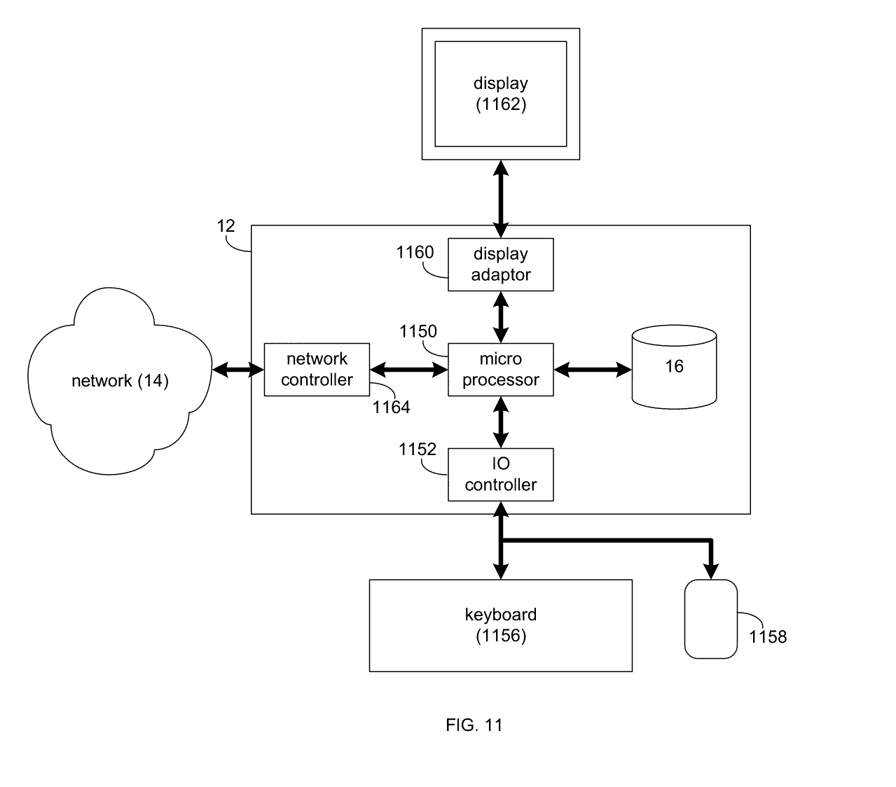

Referring also to FIG. 11, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, dealership process 10 may be substituted for computing device 12 within FIG. 11, examples of which may include but are not limited to client electronic devices 28, 30, 32, 34.

Computing system 12 may include microprocessor 1150 configured to e.g., process data and execute instructions/code for dealership process 10. Microprocessor 150 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 1152 may be configured to couple microprocessor 1150 with various devices, such as keyboard 1156, mouse 1158, USB ports (not shown), and printer ports (not shown). Display adaptor 1160 may be configured to couple display 1162 (e.g., a CRT or LCD monitor) with microprocessor 1150, while network adapter 1164 (e.g., an Ethernet adapter) may be configured to couple microprocessor 1150 to network 14 (e.g., the Internet or a local area network).

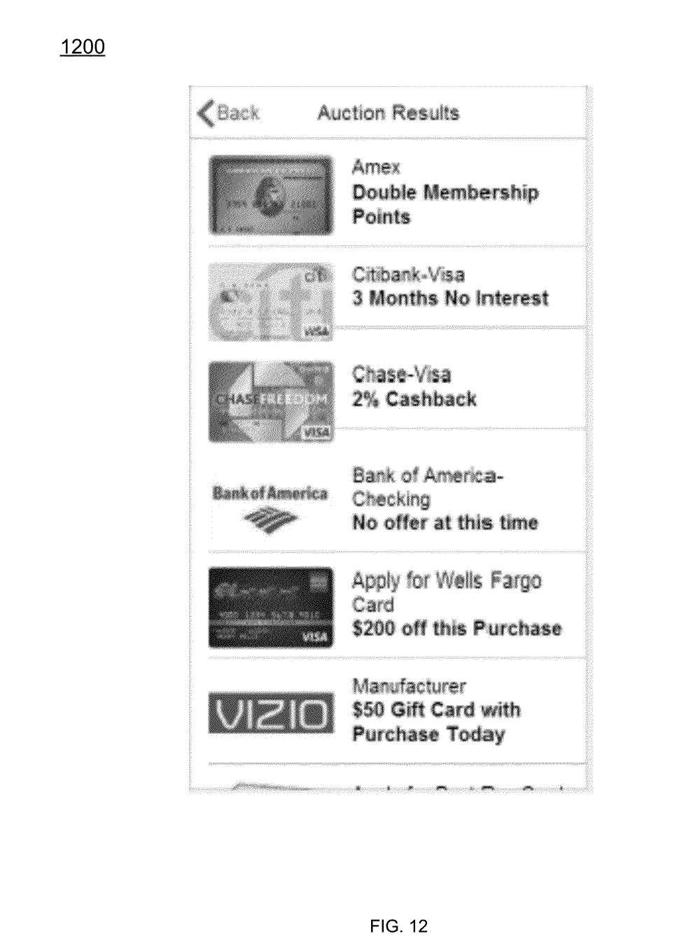

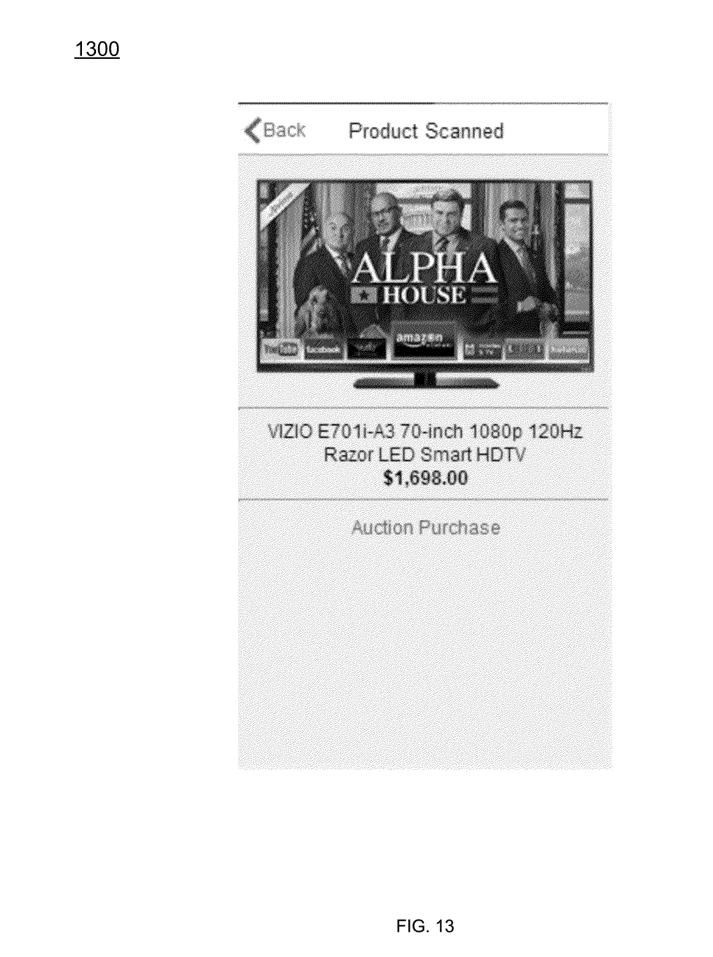

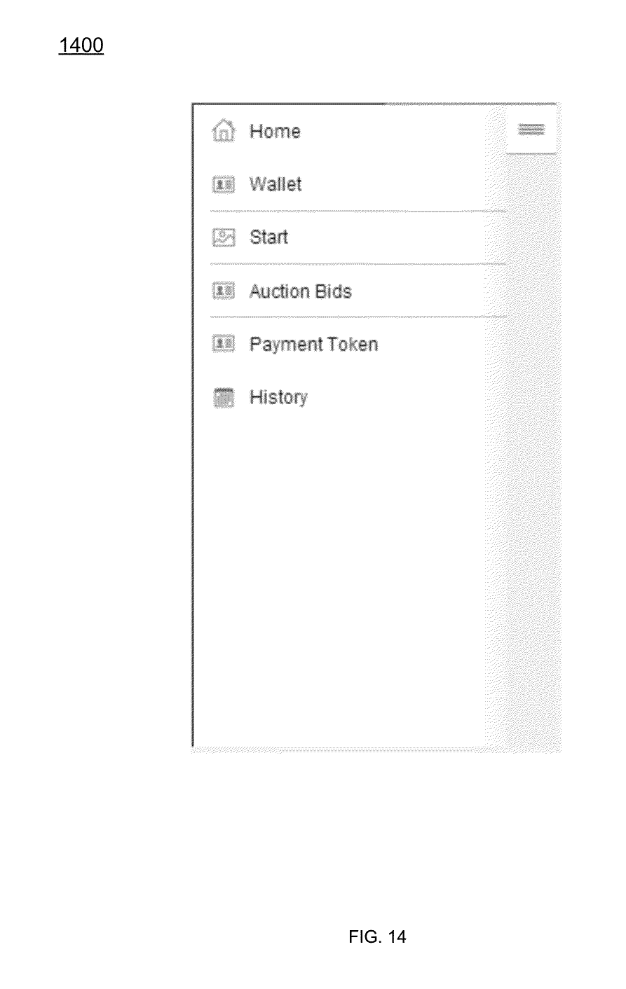

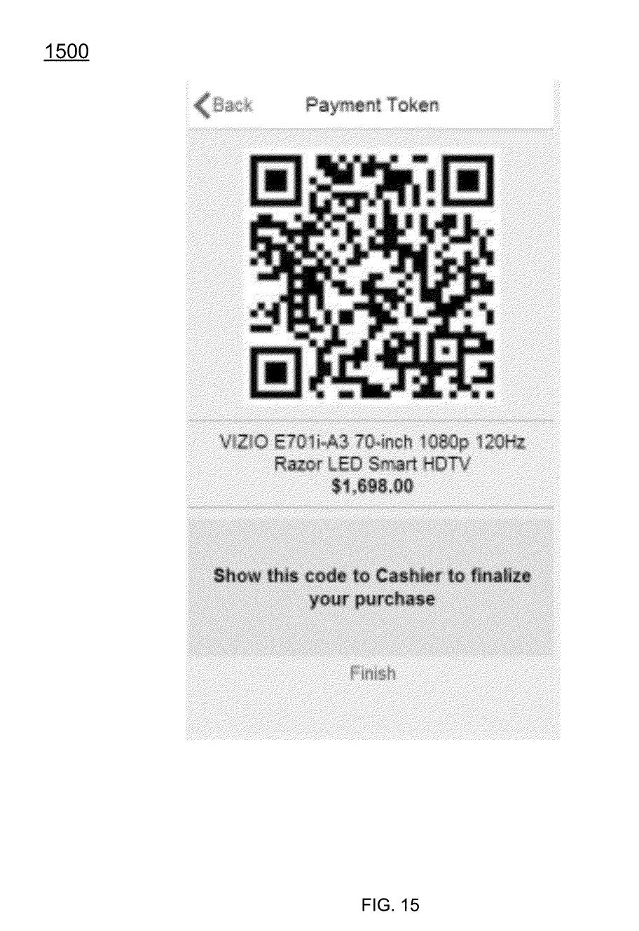

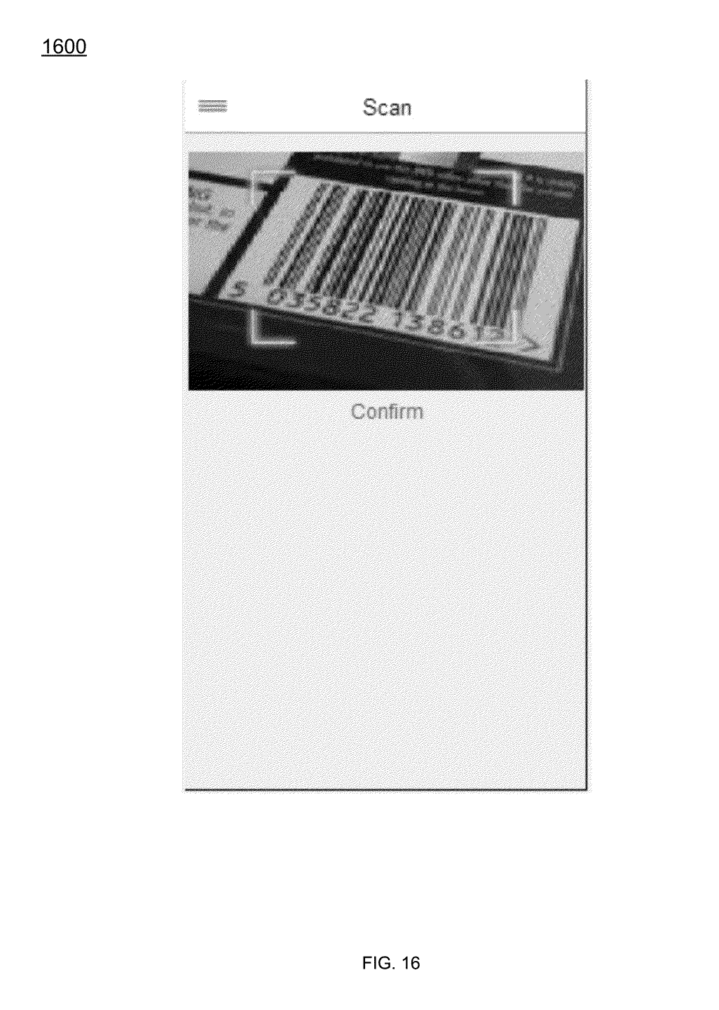

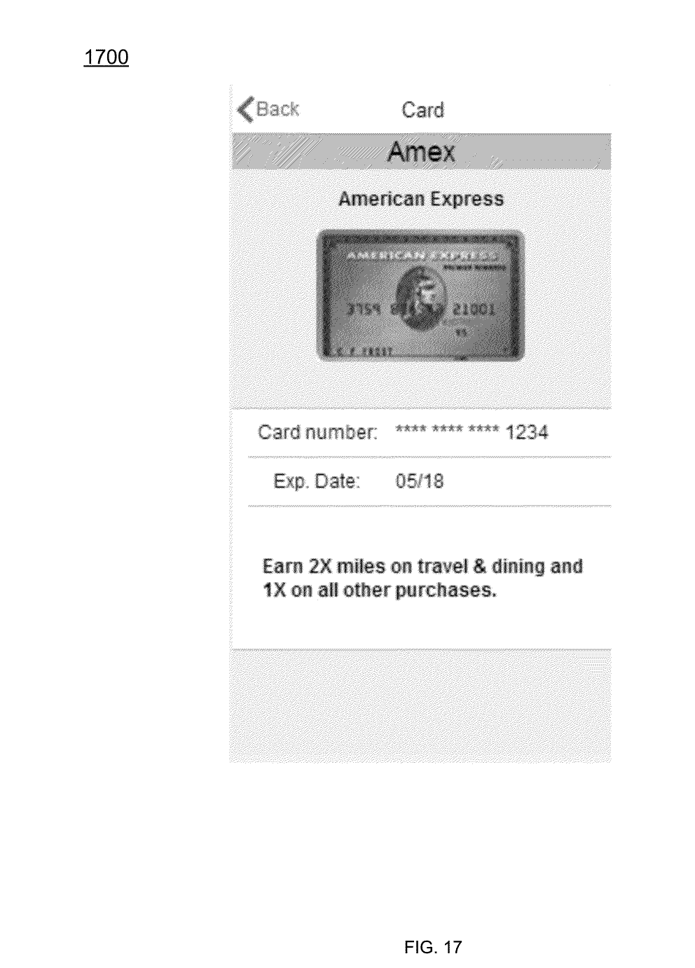

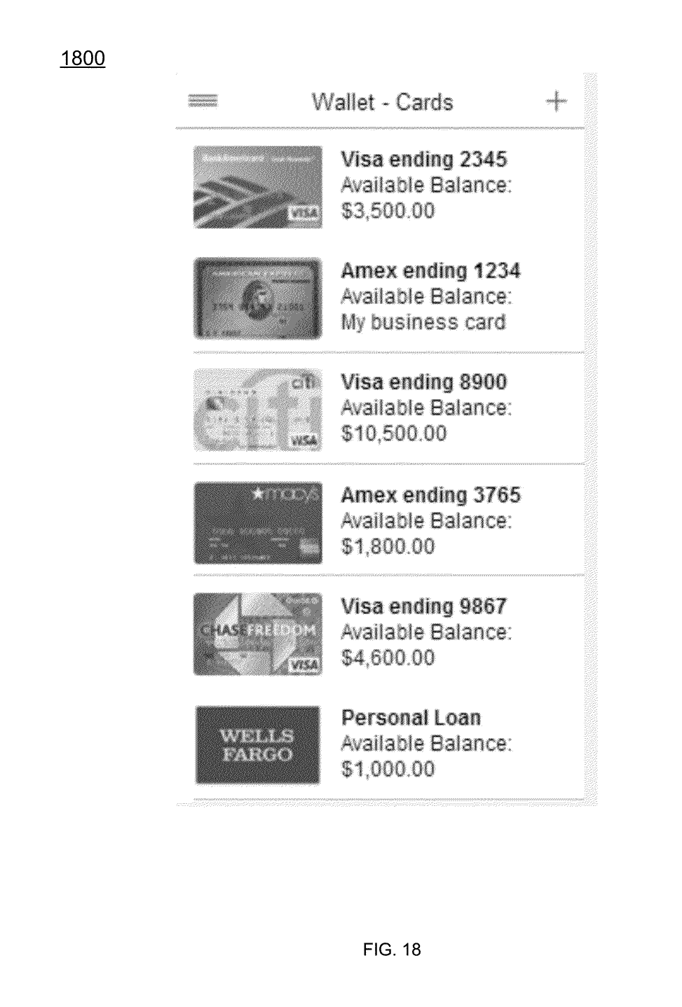

Referring now to FIGS. 12-18, embodiments of payment process 10 depicting examples of graphical user interfaces are shown. FIG. 12 depicts an example of a GUI 1200 that displays various auction results to user, which have been generated via payment process 10. FIG. 13 depicts an example of a GUI 1300 that displays the product scanned to the user in accordance with payment process 10. FIG. 14 depicts an example of a GUI 1400 that displays a user's homepage associated with the client application of payment process 10. FIG. 15 depicts an example of a GUI 1500 that displays the payment token generated by payment process 10, which may be presented to a cashier, for example. FIG. 16 depicts an example of a GUI 1600 that displays the scan functionality associated with payment process 10. FIG. 17 depicts an example of a GUI 1700 that displays a particular credit card available to the user via payment process 10. FIG. 18 depicts an example of a GUI 1800 that displays a virtual wallet of cards that may be available to the user in accordance with payment process 10.

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 350) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, at a server computing device, customer location information and at least one of a product scan or a product purchase amount;
storing at least one customer selected payment method at the server computing device;
communicating at least one of the customer location information and the at least one product scan or product purchase amount to at least one third party server computing device;
receiving, at the server computing device, one or more payment offers from the at least one third party server computing device; and
transmitting the one or more payment offers to a mobile computing device associated with the customer.

2. The computer-implemented method of claim 1 wherein transmitting includes transmitting a user selectable option configured to allow the customer to select from the one or more payment offers.

3. The computer-implemented method of claim 2 further comprising:
transmitting a code configured for display on the mobile computing device, wherein the code corresponds to a customer selected payment offer.

4. The computer-implemented method of claim 1 wherein the at least one third party server computing device is affiliated with one or more of a bank, a credit card company, a retailer, an online payment service and a mobile payment service.

5. The computer-implemented method of claim 1 wherein the one or more payment offers include at least one of a credit card offer, a gift card offer, and a product discount.

6. The computer-implemented method of claim 1 wherein the one or more payment offers are tailored for the customer and are received in response to a possible purchase event notification received from the mobile computing device.

7. The computer-implemented method of claim 3 wherein the server computing device is configured to directly settle a transaction between a retailer and a bank based upon, at least in part, the customer selected payment offer.

8. A computing system including a processor and memory configured to perform operations comprising:
receiving, at a server computing device, customer location information and at least one of a product scan or a product purchase amount;
storing at least one customer selected payment method at the server computing device;
communicating at least one of the customer location information and the at least one product scan or product purchase amount to at least one third party server computing device;
receiving, at the server computing device, one or more payment offers from the at least one third party server computing device; and
transmitting the one or more payment offers to a mobile computing device associated with the customer.

9. The computing system of claim 8 wherein transmitting includes transmitting a user selectable option configured to allow the customer to select from the one or more payment offers.

10. The computing system of claim 9 further comprising:
transmitting a code configured for display on the mobile computing device, wherein the code corresponds to a customer selected payment offer.

11. The computing system of claim 8 wherein the at least one third party server computing device is affiliated with one or more of a bank, a credit card company, a retailer, an online payment service and a mobile payment service.

12. The computing system of claim 8 wherein the one or more payment offers include at least one of a credit card offer, a gift card offer, and a product discount.

13. The computing system of claim 8 wherein the one or more payment offers are tailored for the customer and are received in response to a possible purchase event notification received from the mobile computing device.

14. The computing system of claim 10 wherein the server computing device is configured to directly settle a transaction between a retailer and a bank based upon, at least in part, the customer selected payment offer.

15. A non-transitory computer-readable storage medium having stored thereon instructions that when executed by a machine result in the following operations:
receiving, at a server computing device, customer location information and at least one of a product scan or a product purchase amount;
storing at least one customer selected payment method at the server computing device;
communicating at least one of the customer location information and the at least one product scan or product purchase amount to at least one third party server computing device;
receiving, at the server computing device, one or more payment offers from the at least one third party server computing device; and
transmitting the one or more payment offers to a mobile computing device associated with the customer.

16. The non-transitory computer-readable storage medium of claim 15 wherein transmitting includes transmitting a user selectable option configured to allow the customer to select from the one or more payment offers.

17. The non-transitory computer-readable storage medium of claim 16 further comprising:
transmitting a code configured for display on the mobile computing device, wherein the code corresponds to a customer selected payment offer.

18. The non-transitory computer-readable storage medium of claim 15 wherein the at least one third party server computing device is affiliated with one or more of a bank, a credit card company, a retailer, an online payment service and a mobile payment service.

19. The non-transitory computer-readable storage medium of claim 15 wherein the one or more payment offers include at least one of a credit card offer, a gift card offer, and a product discount.

20. The non-transitory computer-readable storage medium of claim 15 wherein the one or more payment offers are tailored for the customer and are received in response to a possible purchase event notification received from the mobile computing device.
